(19) United States
(12) Patent Application Publication
(10) Pub. No.: US 2026/0370121 A1
(43) Pub. Date: Nov. 19, 2026

(54) VOLTAGE CONTROL DEVICE, PHOTOELECTRIC CONVERSION APPARATUS, VOLTAGE CONTROL METHOD, AND STORAGE MEDIUM

(71) Applicant: CANON KABUSHIKI KAISHA, Tokyo (JP)

(72) Inventors: MASAYA OHTAKE, Kanagawa (JP); AIHIKO NUMATA, Tokyo (JP)

(21) Appl. No.: 19/677,849

(22) Filed: May 14, 2026

(30) Foreign Application Priority Data
May 16, 2025 (JP) 2025-082489

(51) Int. Cl. H02M 1/00; G06F 1/30; H02M 3/156; H02S 50/00

(52) U.S. Cl. CPC H02M 1/0054; G06F 1/305; H02M 1/0019; H02M 3/156; H02S 50/00

(57) ABSTRACT

A voltage control device for observing a load state, changing a switching period, changing response sensitivity and changing the switching period by changing the response sensitivity based on the load state as a result of the observation.

### BACKGROUND

### Field of the Technology

The present disclosure relates to a voltage control device, a photoelectric conversion apparatus, a voltage control method, and a storage medium.

### Description of the Related Art

In switching power circuits that convert direct-current voltages into direct-current voltages with different voltage values, losses during conversion mainly occur during switching. In order to reduce losses during switching, switching periods are set to optimum periods in accordance with load states.

For example, Japanese Patent Laid-Open No. 2021-45021 proposes a voltage control device that determines whether a load is heavy or light based on a value of an output voltage of a switching power circuit and changes a switching period by switching a drive mode.

However, in the configuration of Japanese Patent Laid-Open No. 2021-45021, a value of an output voltage of a switching power circuit is reflected with a delay relative to a timing at which a load is generated by a load device. Accordingly, it takes time to set a switching period to an optimum period in accordance with a load state, and the degree of reduction in loss during switching decreases according to time taken.

### SUMMARY

According to one aspect of the present disclosure, a voltage control device includes: an observation unit configured to observe a load state; a period change unit configured to change a switching period; a response sensitivity change unit configured to change response sensitivity; and a control unit configured to change the switching period by changing the response sensitivity based on the load state as a result of the observation.

Further features of the present disclosure will become apparent from the following description of embodiments with reference to the attached drawings.

### BRIEF DESCRIPTION OF THE DRAWINGS

FIG. 1 is a functional block diagram illustrating a configuration example of a voltage control device according to a first embodiment.

FIG. 2 is a diagram illustrating an example of a signal waveform derived from a voltage value output from a voltage conversion unit and delivered from an observation unit to a period change unit according to the first embodiment.

FIG. 3 is a diagram illustrating a function of a response sensitivity change unit according to the first embodiment.

FIG. 4 is a diagram illustrating a detailed example of an output signal waveform of the voltage conversion unit according to the first embodiment.

FIGS. 5A and 5B are diagrams illustrating an example of a change in frequency characteristics of the voltage control device according to the first embodiment.

FIG. 6 is a diagram illustrating an example of correspondence between an impedance value of the response sensitivity change unit and a measured value of the observation unit according to the first embodiment.

FIG. 7 is a diagram illustrating an example of a relationship between an impedance value of the response sensitivity change unit and a measured value (current value) of the observation unit according to the first embodiment.

FIG. 8 is a flowchart illustrating an example of a voltage control method performed by a control unit according to the first embodiment.

FIG. 9 is a flowchart illustrating another example of the voltage control method by the control unit according to the first embodiment.

FIG. 10 is a diagram illustrating an effect of the example of the voltage control method illustrated in FIG. 8 according to the first embodiment.

FIG. 11 is a diagram illustrating a configuration example of a photoelectric conversion element according to a second embodiment.

FIG. 12 is a diagram illustrating a configuration example of a sensor substrate according to the second embodiment.

FIG. 13 is a diagram illustrating a configuration example of a circuit substrate according to the second embodiment.

FIG. 14 is a diagram illustrating an example of an equivalent circuit of a signal processing circuit corresponding to a pixel of the photoelectric conversion element according to the second embodiment.

FIG. 15 is a diagram illustrating an example of a relationship between an output signal and an operation of the photoelectric conversion element according to the second embodiment.

FIG. 16 is a functional block diagram illustrating a configuration example of a photoelectric conversion apparatus according to the second embodiment.

FIG. 17 is a diagram illustrating data for calculating a statistical value of the number of photons according to the second embodiment.

FIG. 18 is a diagram illustrating a relationship between a measured value of an observation unit and the number of photons counted by the photoelectric conversion element according to the second embodiment.

FIG. 19 is a flowchart illustrating a processing example in which a control unit gives an instruction to change sensitivity based on the number of photons according to the second embodiment.

FIG. 20 is a flowchart illustrating another processing example in which the control unit gives an instruction to change sensitivity based on the number of photons according to the second embodiment.

FIG. 21 is a flowchart illustrating a processing example in which a photoelectric conversion apparatus gives an instruction to change sensitivity based on the number of photons according to a third embodiment.

FIG. 22A is a timing chart illustrating a drive timing example of the photoelectric conversion apparatus according to the second embodiment to make comparison.

FIG. 22B is a timing chart illustrating a drive timing example of the photoelectric conversion apparatus according to the third embodiment.

FIG. 23 is a diagram illustrating a method of driving a photoelectric conversion element according to the third embodiment.

FIG. 24 is a diagram illustrating another method of driving a photoelectric conversion element according to the third embodiment.

FIG. 25 is a flowchart illustrating a processing example of a photoelectric conversion apparatus according to a fourth embodiment.

FIG. 26 is a timing chart illustrating a timing example of a process of the photoelectric conversion apparatus according to the fourth embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

In the present embodiment, a voltage control device that changes a switching period changes response sensitivity in accordance with a load state. Accordingly, the switching period is set to an optimum period in accordance with the load state, a period in which a switching loss occurs is reduced, and power conversion efficiency of a switching power circuit is improved.

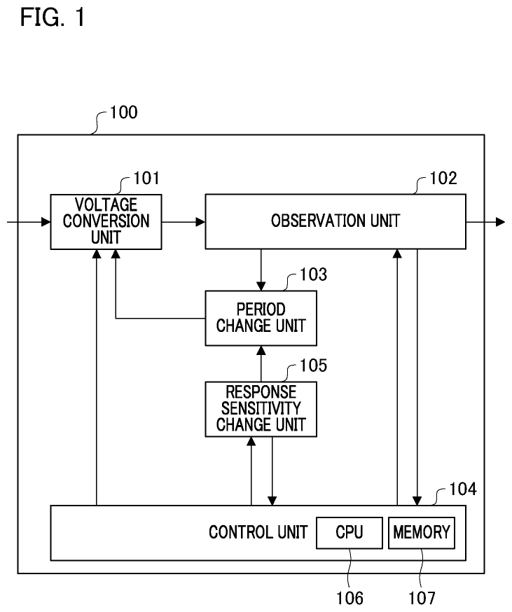

FIG. 1 is a functional block diagram illustrating a configuration example of a voltage control device 100 according to the present embodiment. Some of the functional blocks illustrated in FIG. 1 are implemented by causing a CPU or the like that serves as a computer included in a voltage control device to execute a computer program stored in a memory that serves as a storage medium.

However, some or all of the functional blocks may be implemented by hardware. As the hardware, a dedicated circuit (ASIC), a processor (reconfigurable processor, a DSP), or the like can be used.

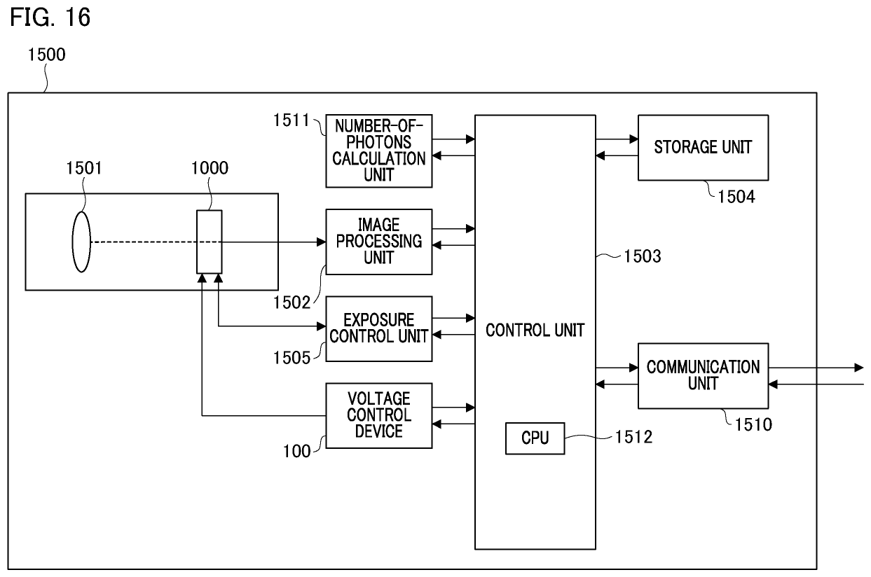

Each functional block illustrated in FIG. 1 may not be embedded in the same casing or may be configured by a separate device connected via a signal line. The above description in FIG. 1 similarly applies to FIG. 16 and the like.

The voltage control device 100 includes a voltage conversion unit 101, an observation unit 102, a period change unit 103, a control unit 104, and a response sensitivity change unit 105.

The voltage conversion unit 101 receives a voltage input from the outside of the voltage control device 100 and changes a level of the voltage. As the level of the voltage to be changed, a voltage with a lower level obtained by stepping down the input voltage may be output or a voltage with a higher level obtained by stepping up the input voltage may be output.

The voltage conversion unit 101 can also maintain the level of the input voltage without changing the level of the voltage. A mechanism for changing the level of the voltage turns on and off a gate voltage of a P-channel FET (not illustrated) in accordance with a direct-current conversion scheme, outputs a rectangular voltage between a drain and a source of the P-channel FET, smooths the voltage using a downstream delay filter (not illustrated), and changes a level of the voltage. A switching element other than the P-channel FET may be used as a substitute.

The observation unit 102 observes one or both of a voltage and a current as a load state. When a voltage is observed, the voltage is observed by comparing a reference voltage (not illustrated) and a voltage supplied from the voltage conversion unit 101. The reference voltage may be fixed or may be variable by the control unit 104.

When a current is observed, a resistor for measurement is inserted in series, a voltage drop at both ends of the resistor is measured, and a measured voltage is divided by inserted resistance to calculate and observe the current. The observed value may include ripple that cannot be fully smoothed due to direct-current conversion of the voltage conversion unit 101 or fluctuation occurring due to a load downstream of the voltage control device 100 in some cases.

Accordingly, stabilization of an observed value using an averaging filter may be achieved. A time required for averaging is generally a few ms to several tens of ms.

The period change unit 103 performs a period change step of changing a switching period (voltage conversion period) of the voltage conversion unit 101. The period change unit 103 is connected to, for example, the gate of the P-channel FET (not illustrated) in the voltage conversion unit 101 and changes a period in which a gate voltage is turned on or off. The period is changed based on the value observed by the observation unit 102 to stabilize a level of a voltage output from the voltage conversion unit 101.

The response sensitivity change unit 105 changes response sensitivity for changing a speed when the period for tuning on or off the gate voltage is changed by the pieord change unit 103 based on the value observed by the observation unit 102. A level of the sensitivity is set by the control unit 104.

The control unit 104 contains a CPU 106 serving as a computer and a memory 107. The control unit 104 functions as a control mechanism that controls an operation of each unit of the entire voltage control device 100 based on a computer program stored in the memory serving as a storage medium.

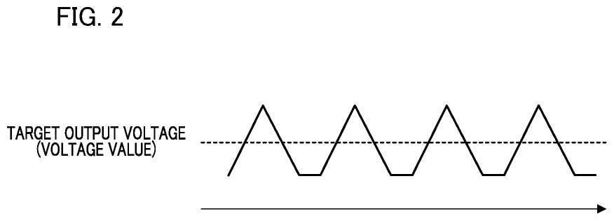

FIG. 2 is a diagram illustrating an example of a signal waveform derived from a voltage value output from the voltage conversion unit 101 and delivered from the observation unit 102 to the period change unit 103 according to the first embodiment. Since the voltage conversion unit 101 has a finite switching period, a waveform that has a predetermined amplitude value centering on a target output voltage is obtained. A measured signal input from the voltage conversion unit 101 to the observation unit 102 may have a current waveform.

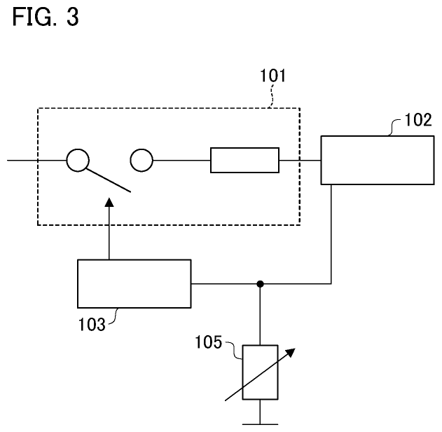

FIG. 3 is a diagram illustrating a function of a response sensitivity change unit 105 according to the first embodiment. A change in sensitivity by the response sensitivity change unit 105 is implemented, for example, by changing a level of impedance.

When impedance of the response sensitivity change unit 105 is low, high-frequency components of a signal supplied from the observation unit 102 to the period change unit 103 are dropped to a ground GND via the response sensitivity change unit 105. Therefore, a signal arriving at the period change unit 103 mainly has low-frequency.

That is, responsiveness to the observation unit 102 becomes low. On the other hand, since the impedance of the response sensitivity change unit 105 is high, high-frequency components are unlikely to pass through the response sensitivity change unit 105, and therefore are likely to be dropped to the ground GND. Accordingly, there are more high-frequency components in a signal arriving at the period change unit 103 than when the impedance of the response sensitivity change unit 105 is low. That is, responsiveness to the observation unit 102 becomes high.

In this way, response sensitivity in the present embodiment is sensitivity at which an output voltage value or an output current value of the voltage control device is read. The higher the response sensitivity is, the higher the responsiveness to a change in the output voltage or the output current is.

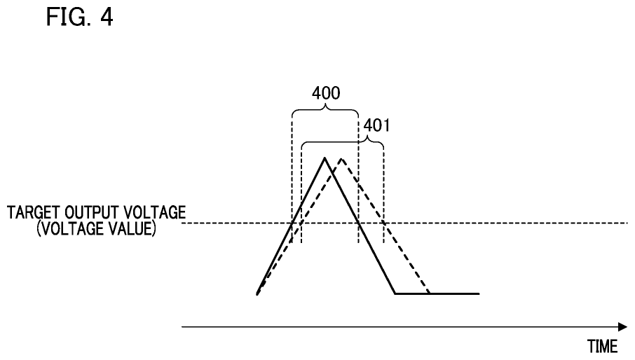

FIG. 4 is a diagram illustrating a detailed example of an output signal waveform of the voltage conversion unit 101 according to the first embodiment, and illustrates only one period in the waveform illustrated in FIG. 2. In the voltage waveform of FIG. 4, a solid line indicates a waveform when the impedance of the response sensitivity change unit 105 is high, and a long dashed line indicates a waveform when the impedance of the response sensitivity change unit 105 is low.

Here, an excess time 400 and an excess time 401 each indicate a time at which a P-channel FET (not illustrated) in the voltage conversion unit 101 is turned on while the target output voltage is exceeded.

The excess time 400 is shorter than the excess time 401 in terms of a time in which the target output voltage is exceeded, and a switching period is a period optimized in accordance with a load level, that is, a target output voltage level.

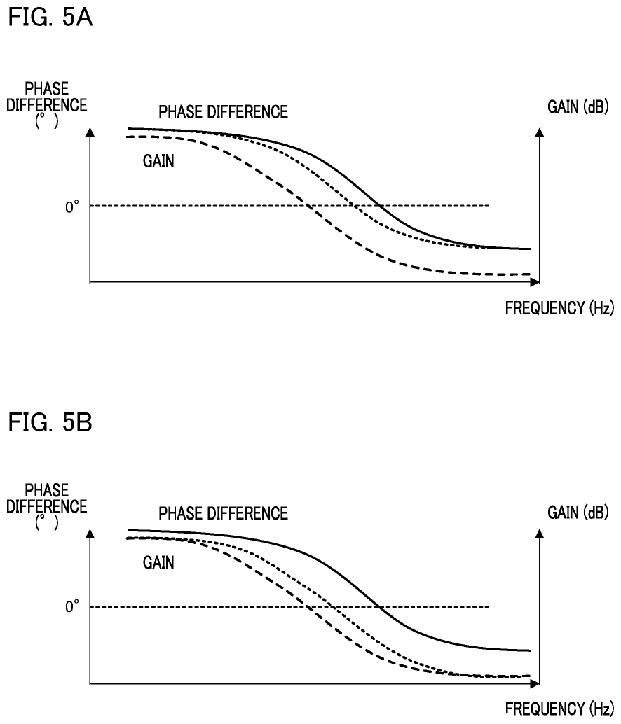

FIGS. 5A and 5B are diagrams illustrating an example of a change in frequency characteristics of the voltage control device 100 according to the first embodiment.

A graph for a gain indicated by a dashed line shows a capability to suppress an amplitude of an output voltage at each frequency. The higher a value of the gain is, the higher the capability to suppress the amplitude of the output voltage is. A graph for a phase difference indicated by a solid line shows how much an instruction for a subsequent period setting of the period change unit 103 is delayed relative to a voltage conversion period of the voltage conversion unit 101 at each frequency. The smaller a value of the phase difference is, the greater a delay is. The instruction for a subsequent period setting of the period change unit 103 is delayed by 360° relative to the voltage conversion period

### At a Phase Difference of 0°.

In general, the smaller the phase difference is, the larger the amplitude of the output voltage after voltage conversion is. The larger the value of the gain is, the larger the amplitude is. The value of the gain at phase difference of 0° is referred to as an evaluation index. It can be evaluated that stability is low when the gain exceeds, for example, −10 dB.

The graph for the phase difference also varies depending on a constituent element of the voltage control device 100, and a particularly dominant factor is an inductor included in a delay filter included in the voltage conversion unit 101. The inductor has characteristics in which as a current becomes larger, the current becomes closer to magnetic saturation and inductance becomes lower. Therefore, as the inductance is lowered, the graph for the phase difference is shifted in a low-frequency direction, as indicated by a dotted line of FIG. 5B.

When the graph for the phase difference is shifted in a low-frequency direction, the value of the gain at a phase difference of 0°becomes larger. Therefore, as the current becomes larger, it is easier for the amplitude of the output voltage to become larger.

The response sensitivity change unit 105 according to the present embodiment mainly changes the graph for the gain. That is, the response sensitivity is changed by changing at least one of the gain and phase in frequency characteristics of the voltage control device.

As the impedance of the response sensitivity change unit 105 becomes higher, the graph for the gain is shifted in a high-frequency direction. When the graph for the gain is shifted in the high-frequency direction, the value of the gain at phase difference of 0° becomes larger. Therefore, as the current becomes larger, it is easier for the amplitude of the output voltage to become larger.

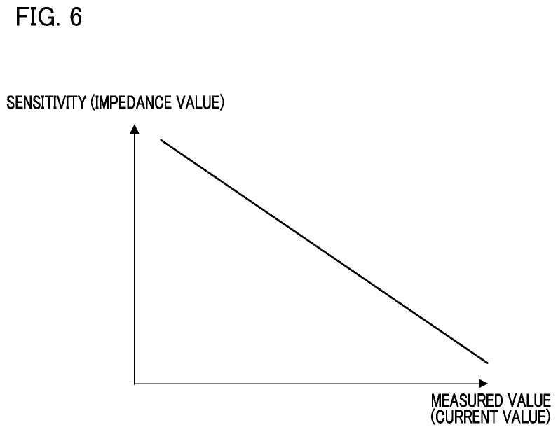

FIG. 6 is a diagram illustrating an example of correspondence between an impedance value of the response sensitivity change unit 105 and a measured value of the observation unit 102 according to the first embodiment. In the present embodiment, for example, response sensitivity is obtained based on an observed value (measured value (current value or the like)) of the observation unit using correspondence such as those in FIG. 6. In FIG. 6, the larger the observed value of the observation unit is, the smaller the response sensitivity is. The smaller the observed value is, the larger the response sensitivity is.

The correspondence is intended to correspond to the fact that the amplitude of the output voltage becomes larger as the output current of the voltage control device 100 becomes larger, as illustrated in FIGS. 5A and 5B.

That is, as a current flowing in the voltage conversion unit 101 becomes larger, the impedance in the response sensitivity change unit 105 is lowered and an increase in the output voltage is reduced. The control unit 104 performs control such that the impedance of the response sensitivity change unit 105 is raised as the current flowing in the voltage conversion unit 101 becomes smaller. Accordingly, when the current flowing in the voltage conversion unit 101 is large, an increase in the amplitude of the output voltage is inhibited.

In the first embodiment, when the current flowing in the voltage conversion unit 101 is small, a time in which the target output voltage is exceeded is shortened as described with reference to FIG. 4.

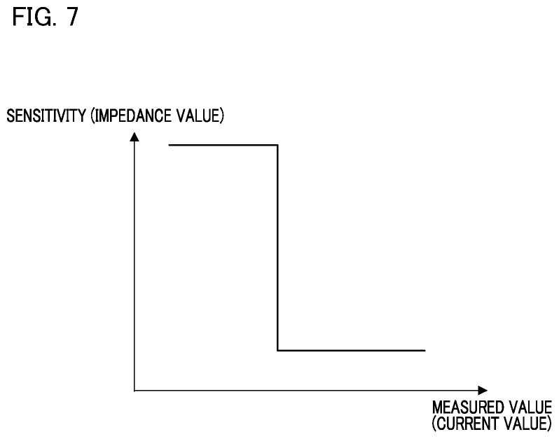

FIG. 7 is a diagram illustrating an example of a relationship between an impedance value of the response sensitivity change unit 105 and a measured value (current value) of the observation unit 102 according to the first embodiment. The relationship between an impedance value of the response sensitivity change unit 105 and a measured value of the observation unit 102 as in FIG. 7 may be switched at any threshold or a plurality of thresholds may be provided.

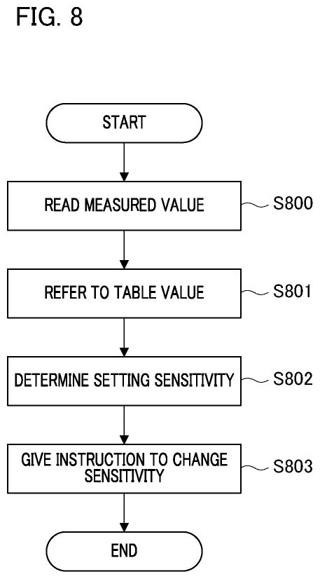

FIG. 8 is a flowchart illustrating an example of a voltage control method performed by the control unit 104 according to the first embodiment. FIG. 8 illustrates a control example in which characteristics such as those in FIG. 6 are implemented. A CPU or the like serving as a computer of the control unit 104 executes a computer program stored in a memory to sequentially perform operations of steps of the flowchart of FIG. 8.

In step S800, an output value of the voltage conversion unit 101 measured by the observation unit 102 is read. An observation target of the observation unit 102 is a voltage or a current serving as a load state and the read value is also the same. Here, step S800 functions as an observation step of observing a load state. After the reading is completed, the process proceeds to step S801.

In step S801, a table in which a correspondence relationship between a value read from the observation unit 102 and a value set in the response sensitivity change unit 105 is recorded in advance is read. The table is recorded in, for example, the memory 107 and can be read by the control unit 104.

Subsequently, in step S802, setting sensitivity is determined. That is, from the output value of the voltage conversion unit 101 read in step S800, a sensitivity value to be set in the response sensitivity change unit 105 is determined using the table. After the determination, the process proceeds to step S803.

In step S803, the sensitivity value determined in step S802 is set in the response sensitivity change unit 105. Here, step S803 functions as a response sensitivity change step of changing the response sensitivity. After the setting is completed, the processing flow of FIG. 8 ends. The processing flow of FIG. 8 is performed periodically.

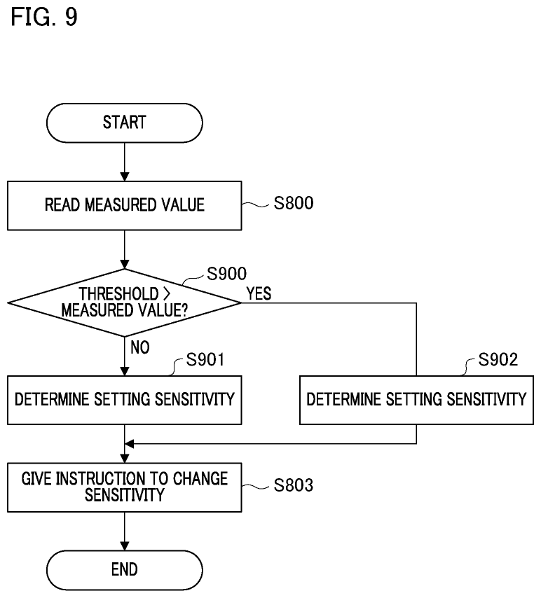

FIG. 9 is a flowchart illustrating another example of the voltage control method by the control unit 104 according to the first embodiment, and illustrates a control example for implementing characteristics such as those in FIG. 7. This control is a control example in which FIG. 7 is realized. Description of a process similar to that of FIG. 8 will be omitted.

A CPU or the like serving as a computer of the control unit 104 executes a computer program stored in a memory to sequentially perform operations of steps of the flowchart of FIG. 9.

In step S900, it is determined whether a value read from the observation unit 102 is less than a predetermined threshold. The predetermined threshold may be set by a user via, for example, a communication unit. A threshold stored in advance in a storage unit (not illustrated) may be used. When the value read from the observation unit 102 is equal to or greater than the predetermined threshold, the process proceeds to step S901. When the value is less than the predetermined threshold, the process proceeds to step S902.

In steps S901 and S902, sensitivity values to be set in the response sensitivity change unit 105 are determined. This value is assumed to be a value stored in advance or a value set by the user. The sensitivity value determined in step S901 is assumed to be a value greater than the sensitivity value determined in step S902. Accordingly, it is possible to implement the characteristics such as those in FIG. 7.

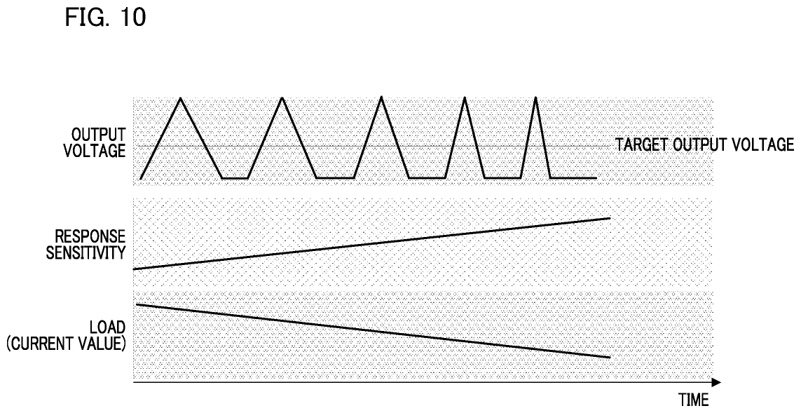

FIG. 10 is a diagram illustrating an effect of the example of the voltage control method illustrated in FIG. 8 according to the first embodiment. As a load decreases, a time in which the target output voltage is exceeded can be shortened for the output voltage by raising the response sensitivity.

That is, in the voltage control device according to the present embodiment, in the control step such as that illustrated in FIG. 8 or 9, the control unit 104 changes a switching period by changing the response sensitivity based on the observation result of the observation step.

Accordingly, it is possible to set the switching period to an optimum period in accordance with the load state, reduce the period in which a switching loss occurs, and improve power conversion efficiency of the switching power circuit.

That is, in the present embodiment, in the voltage control device that changes the switching period, the switching period is changed in accordance with the load state by changing the response sensitivity in accordance with the load state. Accordingly, it is possible to reduce the period in which the switching loss occurs and improve power conversion efficiency of the switching power circuit.

### Second Embodiment

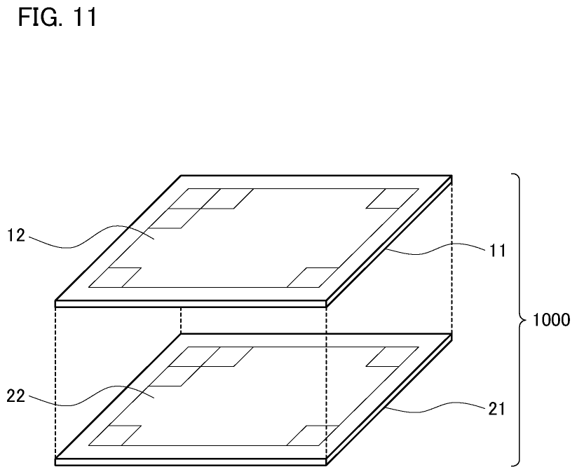

FIG. 11 is a diagram illustrating a configuration example of a photoelectric conversion element according to a second embodiment. In the second embodiment, a photoelectric conversion element that has a stacked structure in which two substrates of a sensor substrate 11 and a circuit substrate 21 are stacked and connected to each other electrically will be described as an example of a photoelectric conversion element 1000.

Here, a photoelectric conversion element that has a non-sacked structure in which a configuration included in a sensor substrate and a configuration included in a circuit substrate are provided in a common semiconductor layer may be used. In FIG. 11, a sensor substrate 11 has a pixel region 12. The circuit substrate 21 has a circuit region 22 where a signal detected in the pixel region 12 is processed.

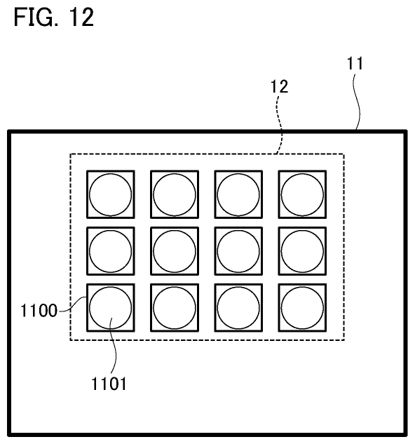

FIG. 12 is a diagram illustrating a configuration example of the sensor substrate 11 according to the second embodiment. The pixel region 12 of the sensor substrate 11 includes a plurality of pixels 1100 arrayed in a 2-dimensional form over a plurality of rows and a plurality of columns. The pixel 1100 includes, for example, a photoelectric conversion portion 1101 including an avalanche photodiode (hereinafter referred to as an APD). The number of rows and the number of columns of the pixel array configuring the pixel region 12 are not limited to the example illustrated in FIG. 12.

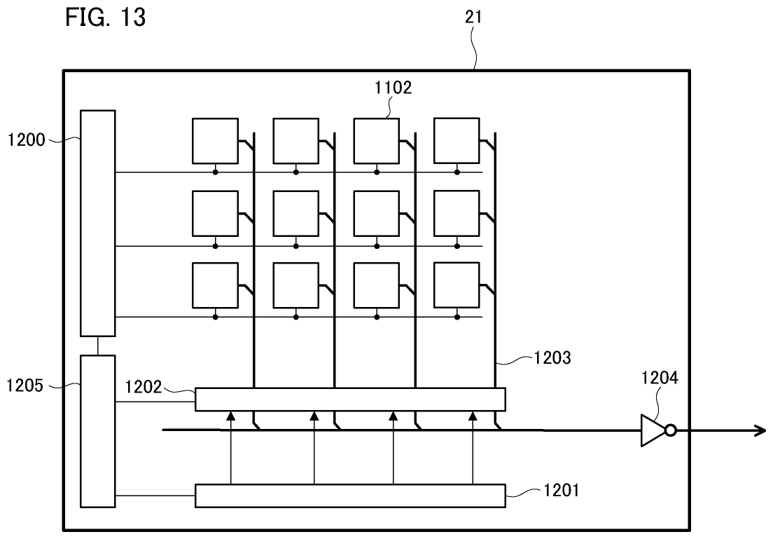

FIG. 13 is a diagram illustrating a configuration example of the circuit substrate 21 according to the second embodiment. The circuit substrate 21 includes a signal processing circuit 1102 that processes a charge photoelectrically converted by the photoelectric conversion portion 1101 in FIG. 2, a reading circuit 1202, a control pulse generation unit 1205, a horizontal scanning circuit 1201, signal lines 1203, and a vertical scanning circuit 1200.

The vertical scanning circuit 1200 receives a control pulse supplied from the control pulse generation unit 1205 and supplies the control pulse to each pixel. In the vertical scanning circuit 1200, a logic circuit such as a shift register or an address decoder is used.

A signal output from the photoelectric conversion portion 1101 is processed by the signal processing circuit 1102. In the signal processing circuit 1102, a counter, a memory, and the like are provided, and digital values are retained in the memory.

The horizontal scanning circuit 1201 inputs the control pulse for sequentially selecting the columns to the signal processing circuit 1102 in order to read signals from the memories of the pixels in which the digital signals are retained.

For a selected column, signals are output to the signal line 1203 from the signal processing circuits 1102 of the pixels in a row direction selected by the vertical scanning circuit 1200. The signals output to the signal line 1203 are output to the outside of the photoelectric conversion element 1000 via the output circuit 1204.

As illustrated in FIGS. 12 and 13, the plurality of signal processing circuits 1102 are provided in a region overlapping the pixel region 12 in a plan view. The vertical scanning circuit 1200, the horizontal scanning circuit 1201, the reading circuit 1202, the output circuit 1204, and the control pulse generation unit 1205 are provided to overlap a region between an end of the sensor substrate 11 and an end of the pixel region 12 in a plan view.

In other words, the sensor substrate 11 has the pixel region 12 and a non-pixel region provided around the pixel region 12. The vertical scanning circuit 1200, the horizontal scanning circuit 1201, the reading circuit 1202, the output circuit 1204, and the control pulse generation unit 1205 are provided in a region overlapping the non-pixel region in a plan view.

The control pulse generation unit 1205 generates a control pulse for controlling an exposure time of each pixel and a control pulse or the like for reading signals from the pixels.

The array of the signal lines 1203 and the array of the reading circuit 1202 and the output circuit 1204 are not limited to FIG. 13. For example, the signal lines 1203 may be arrayed in a row direction and the reading circuit 1202 may be arrayed at a destination to which the signal lines 1203 extend.

One function of the signal processing unit may not be necessarily provided for each photoelectric conversion portion, and a configuration may be used in which one signal processing unit is shared by a plurality of photoelectric conversion portions to sequentially perform signal processing.

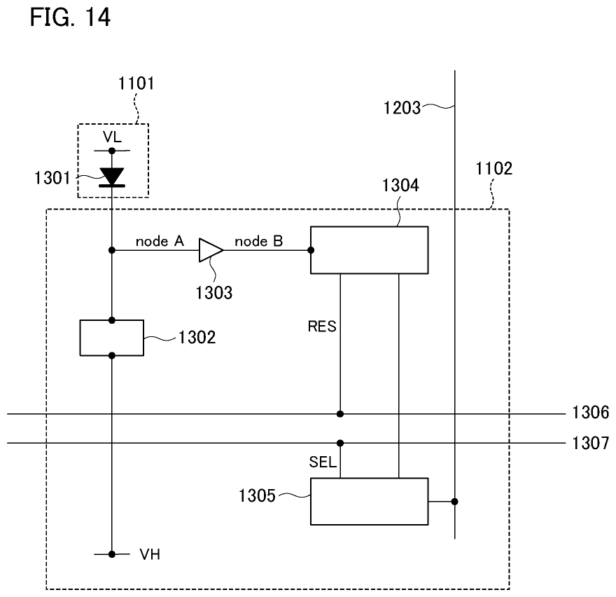

FIG. 14 is a diagram illustrating an example of an equivalent circuit of a signal processing circuit corresponding to a pixel of the photoelectric conversion element according to the second embodiment, and illustrates equivalent circuits of the photoelectric conversion portion 1101 of the pixel 1100 and the signal processing circuit 1102 corresponding to the pixel 1100 in FIGS. 12 and 13.

The avalanche photodiode (APD) 1301 generates a pair of charges corresponding to incident light through photoelectric conversion. Of two nodes of the APD 1301, one node is connected to a power line to which a drive voltage VL is supplied.

Of the two nodes of the APD 1301, the other node is connected via a quench element 1302 to a power line to which a drive voltage VH higher than the drive voltage VL is supplied. In FIG. 14, one node of the APD 1301 is an anode and the other node is a cathode of the APD 1301.

The anode of the APD 1301 is supplied with a reverse-bias voltage (VR) at which the APD 1301 performs an avalanche multiplication operation. Here, the voltage VR is obtained by Formula (1) below.

VR=VL−VH (1)

By supplying such a voltage VR, charges generated by incident light cause avalanche multiplication, and an avalanche current is generated.

When the voltage VR is supplied, there are a Geiger mode in which an operation is performed with a voltage difference between the anode and the cathode that is greater than a breakdown voltage and a linear mode in which an operation is performed with the voltage difference between the anode and the cathode that is near or equal to or less than the breakdown voltage. An APD operating in the Geiger mode is referred to as an SPAD. In the case of the SPAD, the drive voltage VL is, for example, −30 V and the drive voltage VH is, for example, 1 V.

The quench element 1302 is connected to a power line supplied with the drive voltage VH and one node between the anode and the cathode of the APD 1301. The quench element 1302 functions as a load circuit (quench circuit) during signal amplification through the avalanche multiplication and has a function of inhibiting a voltage supplied to the APD 1301 and inhibiting the avalanche multiplication (quench operation).

The quench element 1302 has a function of returning a voltage supplied to the

APD 1301 to the drive voltage VH by flowing a current corresponding to a voltage drop occurring in a quench operation (recharge operation).

The signal processing circuit 1102 includes a waveform shaping unit 1303, a counter circuit 1304, and a selection circuit 1305. FIG. 14 illustrates an example in which the signal processing circuit 1102 includes the waveform shaping unit 1303, the counter circuit 1304, and the selection circuit 1305. In the present embodiment, the signal processing circuit 1102 may include at least one of the waveform shaping unit 1303, the counter circuit 1304, and the selection circuit 1305.

The waveform shaping unit 1303 shapes a change in voltage of the cathode of the APD 1301 obtained during photon detection and outputs a pulse signal. For example, an inverter circuit is used as the waveform shaping unit 1303. FIG. 13 illustrates an example in which one inverter is used as the waveform shaping unit 1303, but a circuit in which a plurality of inverters are connected in series may be used or another circuit that has a waveform shaping effect may be used.

The counter circuit 1304 counts pulse signals output from the waveform shaping unit 1303 and retains a count value. When a control pulse RES is supplied via the drive line 1306, the signals retained in the counter circuit 1304 are reset.

The selection circuit 1305 is supplied with the control pulse SEL from the vertical scanning circuit 1200 in FIG. 12 via a drive line 1307 (not illustrated in FIG. 12) in FIG. 14 and switches between electric connection and non-connection between the counter circuit 1304 and the signal line 1203.

The selection circuit 1305 includes, for example, a buffer circuit or the like that outputs a signal and outputs an output signal from the counter circuit 1304 of the pixel to the signal line 1203.

FIG. 14 illustrates the example in which the output signal is switched by the selection circuit 1305, but a switch such as a transistor may be arrayed between the quench element 1302 and the APD 1301 or between the photoelectric conversion portion 1101 and the signal processing circuit 1102 to switch electric connection.

Similarly, supply of the drive voltage VH or the drive voltage VL supplied to the photoelectric conversion portion 1101 may be switched electrically using a switch such as a transistor.

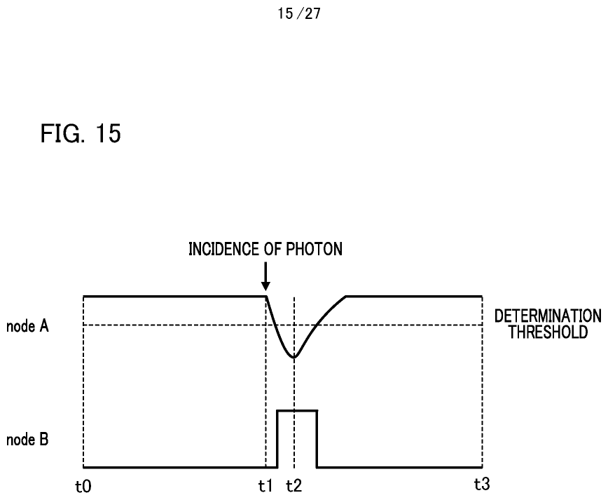

FIG. 15 is a diagram illustrating an example of a relationship between an output signal and an operation of the photoelectric conversion element according to the second embodiment, and schematically illustrates a relationship between an output signal and an operation of the APD 1301. An input side of the waveform shaping unit 1303 is referred to as nodeA and an output side of the waveform shaping unit 1303 is referred to as nodeB. From time t0 to time t1, a VH−VL potential difference is applied to the APD 1301.

When a photon is incident on the APD 1301 at time t1, avalanche multiplication occurs in the APD 1301, an avalanche multiplication current flows to the quench element 1302, and a voltage of nodeA drops.

When a voltage drop amount further increases and a potential difference applied to the APD 1301 decreases, the avalanche multiplication of the APD 1301 stops as in time t2 and a voltage level of nodeA is not dropped by a certain constant value or more.

Thereafter, from time t2 to time t3, a current for compensating for the voltage drop from the drive voltage VL flows to nodeA. At time t3, nodeA is settled to an original potential level. At this time, a portion in which an output waveform exceeds a certain determination threshold in nodeA is wave-shaped by the waveform shaping unit 1303 and is output as a signal in nodeB.

Since a breakdown voltage of the APD 1301 has temperature dependence, it is desirable to set the reverse-bias voltage (VR) in conjunction with temperature. In the present embodiment, a temperature of the photoelectric conversion element 1000 is detected by a sensor and is corrected to the reverse-bias voltage (VR) in accordance with the temperature dependence of the breakdown voltage.

Next, the photoelectric conversion apparatus according to the second embodiment will be described. FIG. 16 is a functional block diagram illustrating a configuration example of a photoelectric conversion apparatus 1500 according to the second embodiment. The photoelectric conversion apparatus 1500 includes the photoelectric conversion element 1000 described in FIGS. 11 to 15, an imaging optical system 1501, an image processing unit 1502, a control unit 1503, a storage unit 1504, and an exposure control unit 1505.

The photoelectric conversion apparatus 1500 includes the voltage control device 100 described in FIGS. 1 to 10 and a communication unit 1510. The photoelectric conversion element 1000 is supplied with power by the voltage control device 100.

The imaging optical system 1501 includes a plurality of lenses and a holding member that holds the lenses. Zoom or focus can be controlled by a drive motor or the like. Further, a configuration may be used in which an infrared cutoff filter or the like that is a filter transmitting or attenuating a specific waveform can be inserted and removed.

A signal output from the photoelectric conversion element 1000 is subjected to various types of pixel processing such as black level correction, gamma curve adjustment, noise reduction, and data compression in addition to image generation and correction processing in the image processing unit 1502 to generate final image data.

The image processing unit 1502 performs processing such as white balance correction and color conversion when an on-chip RGB color filter is arrayed on a light reception surface of the photoelectric conversion element 1000. The image processing unit 1502 calculates a luminance evaluation value for auto exposure (AE) control from the acquired pixel data.

In the AE, an exposure time and/or a digital gain is set so that the image data with appropriate brightness is obtained. The appropriate brightness is, for example, intermediate brightness or the like in which a saturation amount of data is small.

The image processing unit 1502 can also change brightness of image data by computationally changing brightness of pixel data output from the photoelectric conversion element 1000 through the digital gain. In the present embodiment, data input to the image processing unit 1502 is referred to as pixel data and data output from the image processing unit 1502 is referred to as image data.

The storage unit 1504 can temporarily store or read image data output by the image processing unit 1502. Further, the storage unit 1504 may serve as a storage region of a computer program executed by a CPU 1512 of the control unit 1503 to be described below, a storage region of various parameters, or a work region where a computer program is being executed.

The communication unit 1510 converts the image data in conformity with a predetermined communication protocol, and then delivers the converted data to an external device (a client device not illustrated). The communication unit 1510 may also perform, for example, a compression encoding process such as H.264 or H.265.

The communication unit 1510 receives a setting command or the like for various parameters from the external device (not illustrated), outputs the setting command to the control unit 1503, and also transmits the image data or the like to the external device at the same time. The external device can give an instruction for zoom, an instruction for focus, or the like to the photoelectric conversion apparatus 1500 and can also enlarge and display the delivered image.

The photoelectric conversion apparatus 1500 can acquire operation information or control information of the external device. In the present embodiment, a system that includes a photoelectric conversion apparatus or the like in addition to the external device is referred to as an imaging system.

The exposure control unit 1505 determines exposure parameters of the photoelectric conversion apparatus 1500. The exposure parameters include an exposure time (a charge accumulation period or a shutter opening time) or a digital gain. The exposure control unit 1505 acquires an evaluation value of the AE from the photoelectric conversion element 1000. The exposure control unit 1505 can also read a luminance value or the like calculated by an evaluation value calculation unit (not illustrated) included in the photoelectric conversion element 1000 through serial communication from the photoelectric conversion element 1000.

The control unit 1503 contains the CPU 1512 serving as a computer, comprehensively controls each constituent element of the photoelectric conversion apparatus 1500 by executing a computer program stored in the storage unit 1504, and performs setting of various parameters or data transmission and reception instructions.

A number-of-photons calculation unit 1511 calculates a statistical value (for example, a sum, an average, or the like) of the number of photons incident on the photoelectric conversion element 1000 from AE evaluation values acquired by the image processing unit 1502 or the exposure control unit 1505. Alternatively, the number-of-photons calculation unit 1511 may calculate a statistical value (for example, a sum, an average, or the like) of the number of photons based on pixel data before image processing that is output from the photoelectric conversion element 1000 and received by the image processing unit 1502.

Since the pixel data output from the photoelectric conversion element 1000 can be received at each imaging frame interval, a calculation interval of the number-of-photons calculation unit 1511 is also an imaging frame interval. The AE evaluation value acquired by the image processing unit 1502 or the exposure control unit 1505 is also updated at each imaging frame interval.

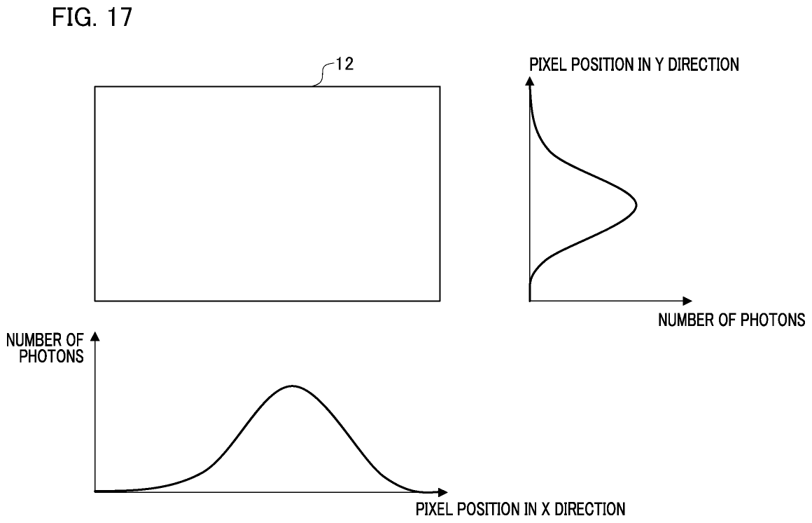

FIG. 17 is a diagram illustrating data for calculating a statistical value of the number of photons according to the second embodiment, and illustrates pixel data of the photoelectric conversion element 1000 along a pixel array of the pixel region 12.

The number-of-photons calculation unit 1511 acquires a sum as the statistical value of the number of photons from the pixel data as illustrated in FIG. 17. Here, data input to the number-of-photons calculation unit 1511 is acquired by the image processing unit 1502 or the exposure control unit 1505.

When the image processing unit 1502 acquires the data input to the number-of-photons calculation unit 1511, the control unit 1503 extracts the pixel data read from the photoelectric conversion element 1000 at a stage before image processing and inputs the extracted pixel data to the number-of-photons calculation unit 1511.

When the exposure control unit 1505 acquires the input data to the number-of-photons calculation unit 1511, for example, the evaluation value calculation unit (not illustrated) in the photoelectric conversion element 1000 calculates, for example, a sum or the like as the statistical value of the number of photons. Then, the control unit 1503 reads the sum via the exposure control unit 1505 and inputs the sum to the number-of-photons calculation unit 1511.

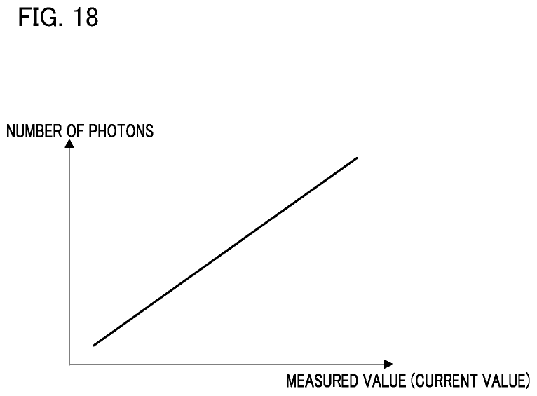

FIG. 18 is a diagram illustrating a relationship between a measured value of the observation unit 102 and the number of photons counted by the photoelectric conversion element 1000 according to the second embodiment.

Since power necessary in the photoelectric conversion element 1000 is proportional to a count number of the number of photons, load power necessary in the voltage control device 100 can be calculated from the count number of the photons with high accuracy.

That is, in the present embodiment, the observation unit that observes a load state includes the number-of-photons calculation unit 1511 that obtains the number of photons from an output value of the photoelectric conversion element. In the present embodiment, a relationship illustrated in FIG. 18 is stored in advance as a table in the storage unit 1504.

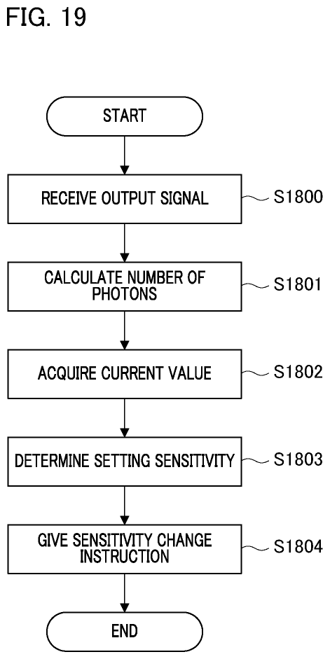

FIG. 19 is a flowchart illustrating a processing example in which the control unit 1503 gives an instruction to change sensitivity based on the number of photons according to the second embodiment. Description of processing similar to that of FIG. 8 will be omitted. A CPU or the like serving as a computer of the control unit 1503 executes a computer program stored in a memory to sequentially perform operations of steps of the flowchart of FIG. 19.

In step S1800, the image processing unit 1502 or the exposure control unit 1505 receives an output signal of the photoelectric conversion element 1000, and the control unit 1503 acquires the received data.

Subsequently, in step S1801, the control unit 1503 inputs the data received in step S1800 to the number-of-photons calculation unit 1511. The number-of-photons calculation unit 1511 calculates a sum of the number of photons based on the input data. Thereafter, the control unit 1503 reads the sum of the number of photons.

In step S1802, a measured value (current value) in the observation unit 102 is acquired from the sum of the number of photons with reference to a first conversion table indicating, for example, the relationship as illustrated in FIG. 18 and stored in advance in the storage unit 1504.

Subsequently, in step S1803, sensitivity to the measured value in the observation unit 102 is acquired and determined with reference to a second conversion table indicating, for example, the relationship as illustrated in FIG. 6 and stored in the storage unit 1504.

Then, in step S1804, the control unit 1503 outputs an instruction to change response sensitivity and sets the sensitivity value determined in step S1803 in the response sensitivity change unit 105. In this way, in step S1801 to S1804, the setting value of the response sensitivity is changed in accordance with the number of photons obtained by the number-of-photons calculation unit 1511. After the setting is completed, the processing flow of FIG. 19 ends. The processing flow of FIG. 19 is periodically performed.

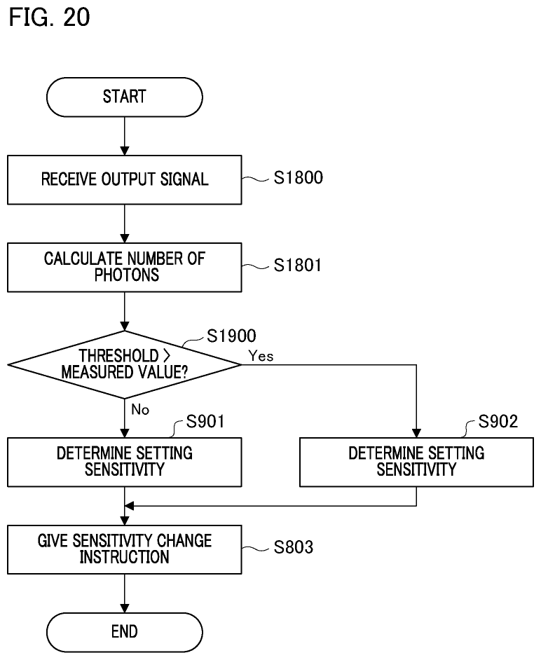

FIG. 20 is a flowchart illustrating another processing example in which the control unit 1503 gives an instruction to change sensitivity based on the number of photons according to the second embodiment. Description of processing similar to those in FIGS. 8, 9, and 18 will be described.

A CPU or the like serving as a computer of the control unit 1503 executes a computer program stored in a memory to sequentially perform operations of steps of the flowchart of FIG. 20.

In step S1900, it is determined whether the number of photons (measured value) exceeds a predetermined threshold. A user can set the predetermined threshold using a communication mechanism (not illustrated). A threshold stored in advance in the storage unit may be used. When the number of photons (measured value) is equal to or greater than the predetermined threshold, the process proceeds to step S901. When the number of photons is less than the predetermined threshold, the process proceeds to step S902.

In the first embodiment, since fluctuation occurring due to a load downstream of the voltage control device 100 can be stabilized using an averaging filter in the observation unit 102, delay occurs until the measured value can be referred to. Since an output voltage of the voltage control device 100 also has an amplitude, there is a limit to an improvement in measurement accuracy.

In the second embodiment, however, since a load can be predicted from the number of photons with high accuracy and a measurement delay element such as an averaging filter can also be reduced, sensitivity set in the period change unit 103 can be optimized at a higher speed. Accordingly, it is possible to further reduce a period in which a switching loss of the voltage control device 100 occurs and to further improve power conversion efficiency of the switching power circuit.

### Third Embodiment

The voltage control device according to the second embodiment receives an output signal corresponding to one frame from the photoelectric conversion element, and then give the instruction to change sensitivity. Therefore, until the output signal is received and the instruction to change sensitivity is given, delay due to, for example, the signal processing of steps S1801 to S1803 of FIG. 19 may occur.

As described above, in the second embodiment, the sensitivity is changed in accordance with a current flowing in the power circuit. In particular, in the voltage control device according to the second embodiment, an improvement in power conversion efficiency is implemented using the fact that the current flowing in the power circuit is determined by photons incident on the avalanche photodiode.

Specifically, by predicting the current flowing in the power circuit at a high speed and with high accuracy based on the number of photons and changing the response sensitivity of the power circuit to an optimum value in accordance with the current, it is possible to further improve the power conversion efficiency.

However, in the voltage control device according to the third embodiment, before the output signal corresponding to one frame is received from the photoelectric conversion element, a part of the output signal corresponding to one frame is received in advance and the instruction to change sensitivity is given based on the signal.

Accordingly, it is possible to reduce delay until the output signal is received and the instruction to change sensitivity is given, and predict the current flowing in the power circuit with a higher speed. As a result, it is possible to further improve the power conversion efficiency.

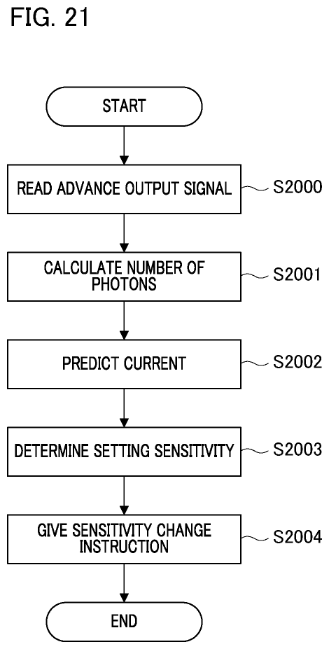

A flowchart in which the instruction to change sensitivity is given based on the number of photons in the photoelectric conversion apparatus according to the third embodiment will be described with reference to FIGS. 21 to 23.

FIG. 21 is a flowchart illustrating a processing example in which a photoelectric conversion apparatus gives an instruction to change sensitivity based on the number of photons according to a third embodiment. A CPU or the like serving as a computer of the control unit 1503 executes a computer program stored in a memory to sequentially perform operations of steps of the flowchart of FIG. 21.

In the present embodiment, the photoelectric conversion element sequentially reads pixel data of all the pixels periodically for each full-frame period, and non-destructively reads the advance output signal from the photoelectric conversion element after an exposure time (accumulation period) shorter than the full-frame period passes after start of the full-frame period.

That is, when the counter circuit 1304 counts an output from the ADP as illustrated in FIG. 14, the count value can be read halfway. Therefore, the above advance output signal can be read non-destructively before the full-frame period passes.

In step S2000 of FIG. 21, an output signal in advance (advance output signal) from the photoelectric conversion element as described above is received. In step S2001, the number of photons is calculated based on the advance output signal. In the calculation of the number of photons, as described with reference to FIG. 17, the number of photons may be calculated by, for example, a method of obtaining a statistical value such as a sum of the number of photons.

Subsequently, in step S2002, the current value is predicted from the number of photons obtained in step S2001 using the first conversion table as illustrated in FIG. 18. At this time, a current necessary for one entire frame is calculated based on a ratio of an exposure time of the advance output signal (an exposure time from start of full-frame exposure to acquisition of the advance output signal) to an exposure time of an output signal corresponding to the full frame (hereinafter referred to as a main output signal).

Subsequently, in step S2003, a setting value of the response sensitivity is determined from the current value predicted in step S2002 using the second conversion table indicating the relation as illustrated in FIG. 6. In step S2004, the instruction to change the sensitivity is given to the voltage control device 100. Upon receiving the instruction, the voltage control device 100 changes the response sensitivity.

In this way, in the present embodiment, before the main output signal that is an output signal corresponding to one frame is received from the photoelectric conversion element, the advance output signal that is an output signal of a part of one frame is received in advance, and the response sensitivity is changed based on the number of photons obtained from the advance output signal.

The number of photons of the main output signal is predicted based on the number of photons of the advance output signal and a ratio of an accumulation time of the advance output signal to an accumulation time of the main output signal, and the response sensitivity is changed based on the predicted number of photons of the main output signal.

Thereafter, the processing flow of FIG. 21 ends. The processing flow of FIG. 21 periodically starts, for example, in synchronization with a start timing of the full frame.

Next, effects of the photoelectric conversion apparatus according to the present embodiment will be described with reference to the timing chart of the control flow.

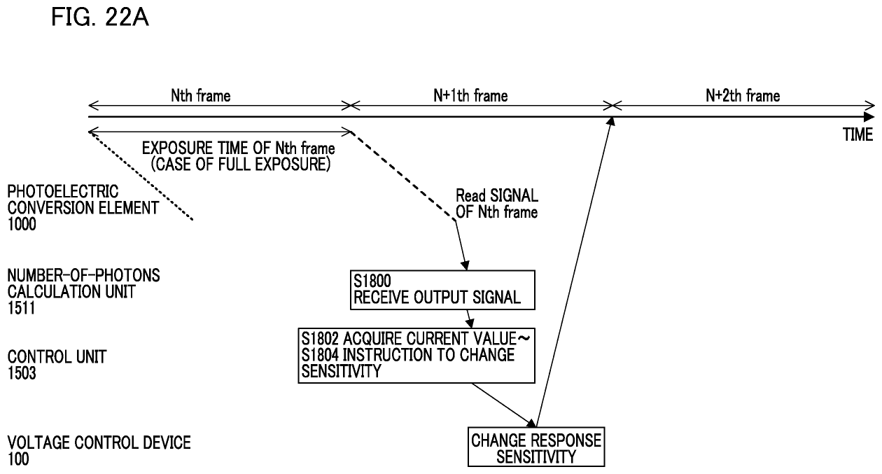

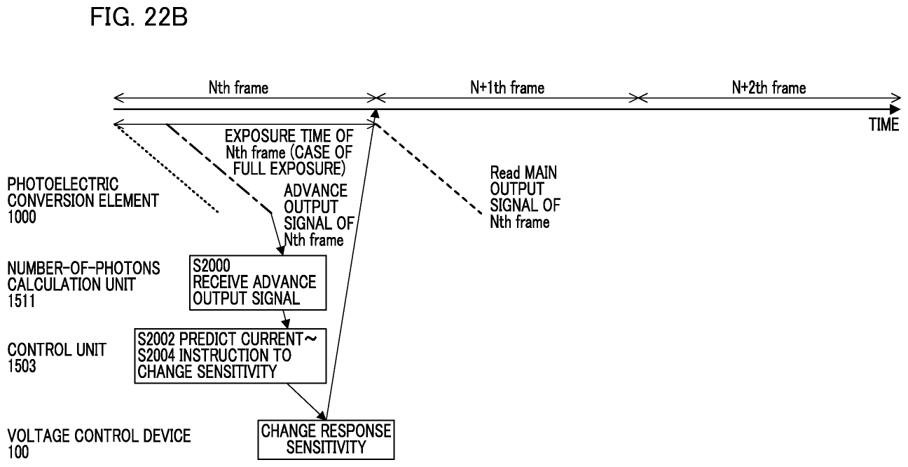

FIG. 22A is a timing chart illustrating a drive timing example of the photoelectric conversion apparatus according to the second embodiment to make comparison. FIG. 22B is a timing chart illustrating a drive timing example of the photoelectric conversion apparatus according to the third embodiment.

A CPU or the like serving as a computer of the control unit 1503 executes a computer program stored in a memory to sequentially perform operations of steps of the timing charts of FIGS. 22A and 22B.

As illustrated in FIG. 22A, the photons counted within an exposure time (accumulation time) of an N frame (Nth full frame) is read after exposure of the Nth frame ends, that is, the N+1 frame starts.

Accordingly, after the output signal is acquired in step S1800, the instruction to change response sensitivity is given in step S1804, and reflection of a change in voltage may occur in an N+2th frame at the earliest. Therefore, when brightness of an environment significantly changes over time and a subject significantly moves, prediction of a current flowing in the power circuit may be delayed and the power conversion efficiency may deteriorate.

However, in the photoelectric conversion element according to the third embodiment, as illustrated in FIG. 22B, the current is predicted or the instruction to change sensitivity is given using an advance output signal read during an exposure period of the Nth frame rather than the main output signal acquired after end of the exposure of the Nth frame.

Accordingly, it is possible to reflect the change in voltage in the N+1th frame. Therefore, even when brightness of an environment significantly changes over time and a subject significantly moves, a current flowing in the power circuit can be predicted with high accuracy and the power conversion efficiency can be further improved.

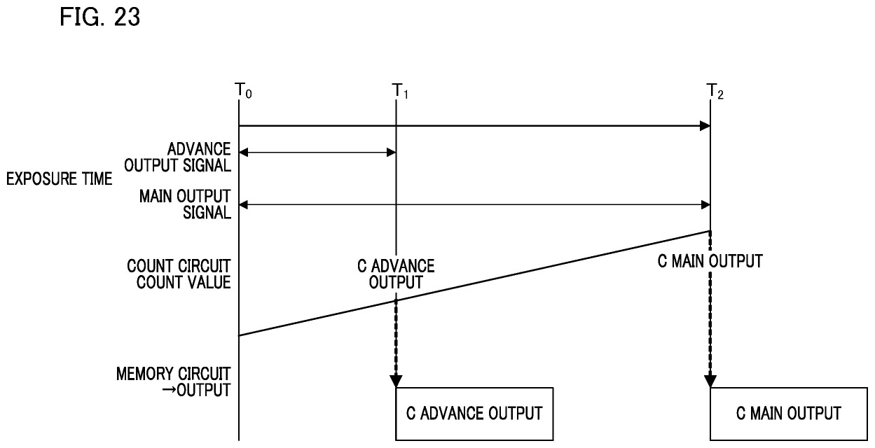

FIG. 23 is a diagram illustrating a method of driving a photoelectric conversion element according to the third embodiment and a diagram illustrating a method of driving the photoelectric conversion element to acquire an advance output signal during a full-frame period in addition to the main output signal whenever the full frame ends. A case where an exposure time of the Nth frame is a full-frame period (T0 to T2) will be described as an example in FIG. 23.

At time T0, the counter circuit 1304 of each pixel is reset and exposure of the Nth frame (accumulation, that is, a count operation) starts. At time T1, a count value “C advance output” counted during an exposure time (accumulation period) until then is stored once in a memory circuit.

Thereafter, from time T1, the count value “C advance output” stored in the memory circuit is read as an advance output signal from the photoelectric conversion element via a buffer. Thereafter, at time T2 at which the exposure time corresponding to the Nth frame ends, a count value “C main output” corresponding to the full frame is stored in the memory circuit.

Then, the count value “C main output” stored in the memory circuit is read as a main output signal together with start of the N+1th frame (time T2). By driving the photoelectric conversion element in this way, it is possible to predict the current or the instruction to change sensitivity at an early timing using the advance output signal. As a result, it is possible to further improve the power conversion efficiency.

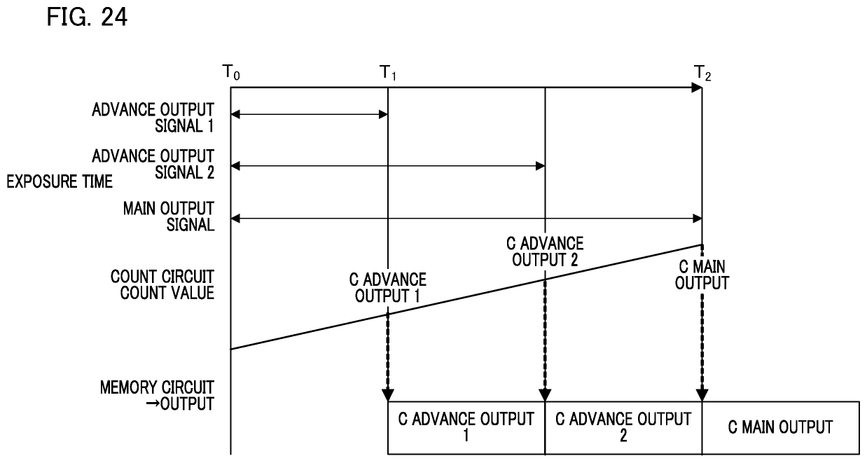

FIG. 24 is a diagram illustrating another method of driving a photoelectric conversion element according to the third embodiment. FIG. 24 illustrates an example in which an advance output signal is acquired a plurality of times during the full frame (one frame). That is, it is possible to improve accuracy of the current prediction and further improve the power conversion efficiency by acquiring the advance output signal the plurality of times during one frame.

In the case of the example in FIG. 24, based on a ratio of the number of photons of each of a plurality of advance output signals acquired in advance to the number of photons of the main output signal, an acquisition timing of a subsequent advance output signal or a length of an exposure time may be controlled.

Specifically, the acquisition timing of the subsequent advance output signal is preferably made earlier by an absolute value of a logarithm of a ratio of the number of photons, for example, per unit time obtained from the plurality of advance output signals acquired in advance.

The acquisition timing of the advance output signal may be controlled based on the plurality of advance output signals and an accumulation time of the advance output signals.

A data amount of the advance output signal less than that of the main output signal may be read by a method such as decimation and reading of signals from the photoelectric conversion element or limiting and reading of a region. That is, a data amount of the advance output signal may be reduced more than a data amount of the main output signal.

By reducing and reading the data amount, it is possible to further advance the acquisition timing of the advance output signal, predict the current flowing in the power circuit with accuracy, and further improve the power conversion efficiency.

In FIG. 23, the number of photons incident during times t0 to T1 is used as the advance output signal, and the current is predicted and the instruction to change the sensitivity is given. That is, the number of photons incident during a specific time is used as the advance output signals. However, conversely, information such as the length of a time passing until a specific number of photons is incident may be used as the advance output signal.

Specifically, for example, in addition to a counter that counts the number of photons, the photoelectric conversion element includes a time counter that measures a time. The time counter is reset to time T0, and a “T advance output” that is a time until the number of photons reaches a given number is counted and output.

Since a reciprocal of the number of photons incident per unit time is a time required for one photon to be incident, the “T advance output” is proportional to a reciprocal of brightness of an environment. Accordingly, by using information regarding the “T advance output,” it is possible to predict a current or give an instruction to change sensitivity. As a result, it is possible to further improve the power conversion efficiency.

In this way, the advance output signal may be set to the length of a time until a predetermined number of photons is counted, and the number of photons of the main output signal may be predicted from the reciprocal of the length of the time of the advance output signal and a ratio of an exposure time of the advance output signal to an exposure time of the main output signal. Then, the response sensitivity may be changed based on the predicted number of photons of the main output signal.

In a time having a specific length, brightness of an environment may be predicted using information regarding a time until a first photon is incident. Alternatively, the “C advance output” or the “T advance output” may be compared a plurality of times. Only when there is a difference, it may be determined that a current is changed and the instruction to change sensitivity may be given.

### Fourth Embodiment

A voltage control device according to a fourth embodiment changes response sensitivity in accordance with not only the number of photons but also a setting value of an exposure control unit unlike the voltage control device according to the second embodiment.

As described above, in the first to third embodiments, sensitivity is changed in accordance with a current flowing in the power circuit. In particular, in the voltage control device according to the second embodiment, an improvement in power conversion efficiency is implemented using the fact that the current flowing in the power circuit is determined by photons incident on the avalanche photodiode.

That is, accurate prediction of the number of photons incident on the avalanche photodiode leads to the improvement in power conversion efficiency.

On the other hand, the number of photons incident on the avalanche photodiode is changed by the exposure control unit. Accordingly, the voltage control device according to the fourth embodiment can further improve the power conversion efficiency than the voltage control device according to the second embodiment by changing the response sensitivity in accordance with not only the number of photons but also the setting value of the exposure control unit.

That is, in the present embodiment, an exposure control unit that controls exposure of the photoelectric conversion element is included. The number-of-photons calculation unit obtains the number of photons based on an exposure parameter acquired in the exposure control unit and an output value of the photoelectric conversion element. Then, the response sensitivity is changed in accordance with information regarding the number of photons obtained in this way.

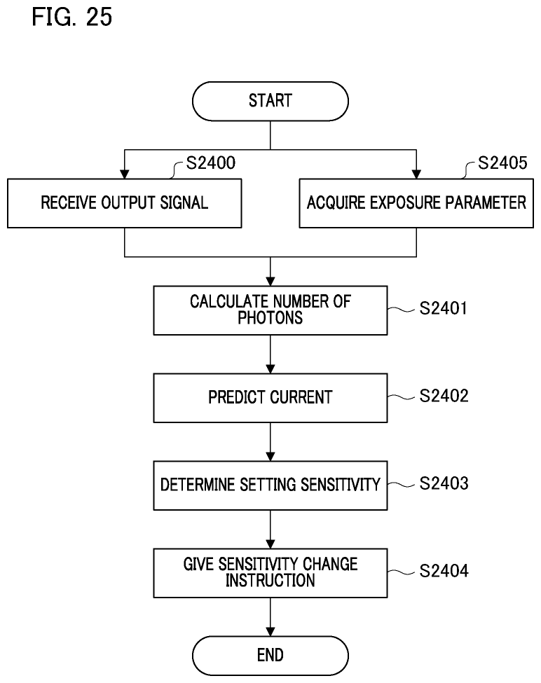

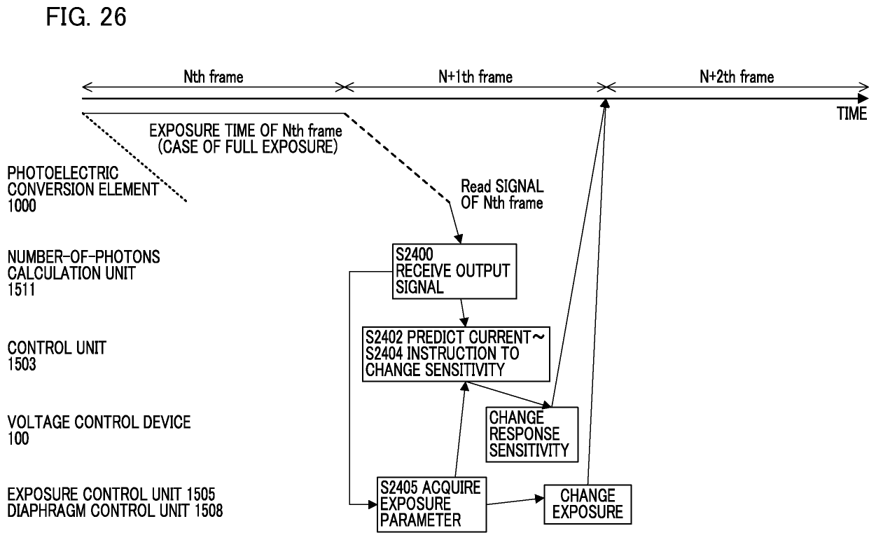

A flowchart in which the photoelectric conversion apparatus according to the present embodiment give an instruction to change sensitivity based on the number of photons will be described with reference to FIGS. 25 and 26. FIG. 25 is a flowchart illustrating a processing example of a photoelectric conversion apparatus according to the fourth embodiment. FIG. 26 is a timing chart illustrating a timing example of a process of the photoelectric conversion apparatus according to the fourth embodiment.

A CPU or the like serving as a computer of the control unit 1503 executes a computer program stored in a memory to sequentially perform operations of steps of the flowchart of FIG. 25 and the timing chart of FIG. 26.

In step S2400 of FIG. 25, an output signal (hereinafter referred to as an advance output signal) read in advance from the photoelectric conversion element is received, and the number of photons is calculated based on an output signal read from the photoelectric conversion element in step S2401. The number of photons may be calculated by a method of obtaining a sum of the number of photons as described with reference to FIG. 16.

On the other hand, in step S2405, in a frame after the voltage control device changes response sensitivity, an exposure parameter (EV value or the like) set by the exposure control unit is acquired. The exposure parameter (EV value or the like) may be an exposure time (TV value), a setting value (AV value) of a diaphragm, or the like.

In step S2402, a current in the frame after the voltage control device changes the response sensitivity is predicted based on the number of photons acquired in step S2401 and the setting value of the exposure time acquired in step S2405.

This is because when the exposure parameter (EV value or the like) between a current frame and a frame after the voltage control device changes the response sensitivity, the number of photons incident on the photoelectric conversion element changes accordingly.

Specifically, when EV0 is an EV value of a current frame and EV1 is an EV value of the frame after the voltage control device changes the response sensitivity, a predicted current value obtained from the number of photons of the current frame may be multiplied by 2 to the power of (EV1-EV0). That is, for example, as the exposure time is longer, in other words, the TV value becomes smaller, a smaller response sensitivity may be set. subsequently, in step S2403, based on the current value predicted in step

S2402, a value of the response sensitivity set in the voltage control device is determined. In step S2404, an instruction to change the sensitivity is given by the voltage control device, the instruction is received, and the response sensitivity is changed by the voltage control device.

Next, description of FIG. 26 will be made. The photons counted within an exposure time of an N frame are read after end of exposure of the Nth frame, that is, in the N+1th frame, and the output signal is received in step S2400.

On the other hand, the exposure control unit controls the EV value based on the

AE evaluation value acquired by the image processing unit or the like. That is, in step S2405, the EV value set by the exposure control unit is acquired in a frame (an N+2th frame in FIG. 26) after the voltage control device changes the response sensitivity.

Then, based on the output signal received in step S2400 and the EV value acquired in step S2405, a current in the N+2th frame is predicted and an instruction to change the response sensitivity accordingly is given in steps S2402 to S2404.

As a result, it is possible to predict a current in which a difference between exposure parameters of the Nth frame and the N+2th frame is taken into account, and to further improve the power conversion efficiency.

The response sensitivity in the N+2th frame may also be changed in accordance with the exposure time (accumulation time) of the N+2th frame acquired in step S2405. That is, the response sensitivity in one frame may be changed in accordance with the accumulation time of the photoelectric conversion element. Specifically, in a time in which the photoelectric conversion element is exposed, the response sensitivity may be set to be less than in a time in which the photoelectric conversion element is not exposed.

When the third and fourth embodiments are combined, a frame in which the response sensitivity is changed is not the N+2th frame but the N+1th frame. Therefore, a frame in which the exposure parameter is acquired in step S2405 is preferably set to the N+1th frame.

Accordingly, even when brightness of an environment significantly changes over time and the exposure parameter is significantly changed for each frame in accordance with the brightness, the current flowing in the power circuit can be predicted with high accuracy and the power conversion efficiency can be further improved.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the voltage control device or the like through a network or various storage media. Then, a computer (or a CPU, an MPU, or the like) of the voltage control device or the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-082489, filed on May 16, 2025, which is hereby incorporated by reference herein in its entirety.

What is claimed is:

1. A voltage control device comprising:
at least one processor; and
a memory in communication with the at least one processor, the memory storing instructions that, when executed by the at least one processor, cause the at least one processor to:
observe a load state;
change a switching period;
change response sensitivity; and
change the switching period by changing the response sensitivity based on the load state as a result of the observation.

2. The voltage control device according to claim 1, wherein the response sensitivity is sensitivity by which an output voltage value or an output current value of the voltage control device is read, and as the response sensitivity becomes higher, responsiveness to the change in the output voltage or the output current becomes higher.

3. The voltage control device according to claim 1, wherein the memory stores further instructions that, when executed by the at least one processor, cause the at least one processor to change the response sensitivity by changing at least one of a gain and a phase in frequency characteristics of the voltage control device.

4. The voltage control device according to claim 1, wherein the memory stores further instructions that, when executed by the at least one processor, cause the at least one processor to obtain the response sensitivity based on a value of the load state.

5. The voltage control device according to claim 1, wherein the memory stores further instructions that, when executed by the at least one processor, cause the at least one processor to decrease the response sensitivity as a value of the load state becomes larger, and to increase the response sensitivity as the value of the load state becomes smaller.

6. A photoelectric conversion apparatus comprising:
a voltage control device including at least one processor and a memory in communication with the at least one processor, the memory storing instructions that, when executed by the at least one processor, cause the at least one processor to observe a load state, change a switching period, change response sensitivity and change the switching period by changing the response sensitivity based on the load state as a result of the observation; and
a photoelectric conversion element to which power is supplied by the voltage control device,
wherein the memory stores further instructions that, when executed by the at least one processor, cause the at least one processor to obtain the number of photons from an output value of the photoelectric conversion element when the load state is observed.

7. The photoelectric conversion apparatus according to claim 6, wherein a setting value of the response sensitivity is changed in accordance with the number of photons requested by a number-of-photons calculation unit.

8. The photoelectric conversion apparatus according to claim 7, wherein the memory stores further instructions that, when executed by the at least one processor, cause the at least one processor to receive an advance output signal that is an output signal of a part of one frame before reception of a main output signal that is an output signal corresponding to one frame from the photoelectric conversion element, and to change the response sensitivity based on the number of photons requested from the advance output signal.

9. The photoelectric conversion apparatus according to claim 8, wherein the memory stores further instructions that, when executed by the at least one processor, cause the at least one processor to predict the number of photons of the main output signal based on the number of photons of the advance output signal and a ratio of an accumulation time of the advance output signal to an accumulation time of the main output signal, and to change the response sensitivity based on the predicted number of photons of the main output signal.

10. The photoelectric conversion apparatus according to claim 8, wherein the memory stores further instructions that, when executed by the at least one processor, cause the at least one processor to set the advance output signal to a length of a time taken until a predetermined number of photons is counted, to predict the number of photons of the main output signal from a reciprocal of a length of a time of the advance output signal and a ratio of an exposure time of the advance output signal to an exposure time of the main output signal, and to change the response sensitivity based on the predicted number of photons of the main output signal.

11. The photoelectric conversion apparatus according to claim 8, wherein the memory stores further instructions that, when executed by the at least one processor, cause the at least one processor to acquire the advance output signal a plurality of times during one frame.

12. The photoelectric conversion apparatus according to claim 11, wherein the memory stores further instructions that, when executed by the at least one processor, cause the at least one processor to control a timing at which the advance output signal is acquired based on a plurality of the advance output signals and an accumulation time of the advance output signals.

13. The photoelectric conversion apparatus according to claim 8, wherein the memory stores further instructions that, when executed by the at least one processor, cause the at least one processor to reduce a data amount of the advance output signal compared with a data amount of the main output signal.

14. The photoelectric conversion apparatus according to claim 7, wherein the memory stores further instructions that, when executed by the at least one processor, cause the at least one processor to request the number of photons based on an exposure parameter acquired during controlling of the photoelectric conversion element and an output value of the photoelectric conversion element.

15. The photoelectric conversion apparatus according to claim 14, wherein the memory stores further instructions that, when executed by the at least one processor, cause the at least one processor to decrease the response sensitivity as an exposure value becomes larger.

16. The photoelectric conversion apparatus according to claim 15, wherein the memory stores further instructions that, when executed by the at least one processor, cause the at least one processor to change the response sensitivity within one frame in accordance with an accumulation time of the photoelectric conversion element.

17. A voltage control method comprising:
observing a load state;
changing a switching period;
changing response sensitivity; and
changing the switching period by changing the response sensitivity based on the load state as a result of the observation.

18. A non-transitory computer-readable storage medium storing a computer program including instructions for executing a voltage control method comprising:
observing a load state;
changing a switching period;
changing response sensitivity; and
changing the switching period by changing the response sensitivity based on the load state as a result of the observation.
